(19) United States
(12) Patent Application Publication
(10) Pub. No.: US 2020/0163391 A1
(43) Pub. Date: May 28, 2020

(54) Stretchable Material, Production Method for Stretchable Material, Stretchable Member, Production Method for Stretchable Member, and Clothing Article

(71) Applicant: 3M INNOVATIVE PROPERTIES COMPANY, St. Paul, MN (US)

(72) Inventors: Kenichiro Morishita, Tokyo (JP); Hiroyasu Nagata, Tokyo (JP); Nobuharu Arai, Kanagawa (JP)

(21) Appl. No.: 16/610,733

(22) PCT Filed: May 10, 2018
(86) PCT No.: PCT/IB2018/053260

§ 371 Date: Nov. 4, 2019

(30) Foreign Application Priority Data
May 11, 2017 (JP) 2017-094928

(51) Int. Cl. A41B 17/00; B32B 3/26; B32B 3/30; B32B 25/08; B32B 25/14; B32B 27/32; B32B 38/04

(52) U.S. Cl. CPC A41B 17/00; B32B 3/266; B32B 3/30; B32B 25/08; B32B 25/14; B32B 27/32; B32B 2555/02; B32B 2038/047; B32B 2250/03; B32B 2307/51; B32B 2307/54; B32B 2307/724; B32B 2307/726; B32B 38/04

(57) ABSTRACT

The stretchable material according to one embodiment is a stretchable material (10) including: a core layer containing an elastomer; and a skin layer provided on a main surface of the core layer, the stretchable material (10) having a plurality of through-holes (15) passing through the core layer and the skin layer, and height (H) of protrusions (15b) formed on the outer edges of the through-holes (15) being not greater than 160 μm.

### TECHNICAL FIELD

One aspect of the present disclosure relates to a stretchable material, a production method for a stretchable material, a stretchable member, and a production method for a stretchable member. Furthermore, another aspect of the present disclosure relates to a clothing article that includes the stretchable material or the stretchable member.

### BACKGROUND ART

There are various known stretchable materials and stretchable members that are used in clothing articles or the like. For example, Patent Document 1 describes a composite material which has elasticity and air permeability and is suitable for the production of an elastic diaper fastening belt and an elastic side part of a diaper. The composite material has a plurality of punched holes and includes an elastic support material formed as a punched film which can be preferentially stretched in one direction.

A knit fabric made of a fiber material is attached to both sides of the elastic support. The knit fabric is adhered to the elastic support material by an adhesive applied with a prescribed pattern. The prescribed pattern is formed by a plurality of striations arranged in a direction perpendicular to the stretching direction of the elastic support.

After the elastic support, which is wound around a roll, is drawn out from the roll, the adhesive is applied in the pattern described above. On the other hand, after the knit fabric, which is wound around a roll, is drawn out from the roll, the knit fabric is conveyed in a direction orthogonal to the conveying direction of the elastic support. The knit fabric that is conveyed in this manner is attached to one or both sides of the elastic support. A laminated composite is formed as the knit fabric is attached to the elastic support, and this laminated composite is subjected to punching. As a result, an elastic side part for a stretchable diaper can be obtained.

### PRIOR ART DOCUMENTS

Patent Document 1: JP 2009-241601 A

### SUMMARY OF THE INVENTION

A plurality of punched holes are formed in the elastic support described above. The punched holes are formed, for example, by a roller with a needle kept at a high temperature. The needle punctures the elastic support in this way, forming punched holes. Incidentally, when the needle is pulled out of the elastic support, in particular, burrs protruding from the outer edges of the punched holes may be formed on the outer edges of the punched holes.

The elastic support described above is used as a diaper, for example, and may be used in locations in close proximity to the human body. Therefore, when the burrs described above are formed, the elastic support may provide rough feeling, which may lead to problems in that the texture is poor. In addition, the elastic support may also be combined with a flexible material such as a nonwoven fabric or used in contact with such a material. In this case, there may be problems in that the elastic support may be caught on the nonwoven fabric and inhibit the function of the nonwoven fabric.

### Means for Solving the Problem

The stretchable material according to one aspect of the present disclosure is a stretchable material including: a core layer containing an elastomer; and a skin layer provided on a main surface of the core layer, the stretchable material having a plurality of through-holes passing through the core layer and the skin layer, and a height of protrusions formed on the outer edges of the through-holes being not greater than 160 μm.

Since the stretchable material of the aspect described above has a plurality of through-holes, the air permeability can be increased. In addition, the height of the protrusions formed on the outer edges of the through-holes is not greater than 160 μm. This prevents the protrusions from penetrating into the through-holes at the time of subsequent processing. When the height of the protrusions is not greater than 160 μm, the texture, for example, can be enhanced.

The height of the protrusions may also be not greater than 100 μm. As a result, the texture, for example, can be further enhanced.

The proportion of the area occupied by the plurality of through-holes with respect to the stretchable material may be from 0.5% to 30%. As a result, the air permeability of the stretchable material, for example, can be increased, and the strength of the stretchable material can be maintained.

The through-holes may have a circular shape, and the diameter of the through-holes may be from 0.2 mm to 3 mm. When the through-holes have a circular shape, fracturing from the through-holes can be inhibited because there are no corners. In addition, when the diameter of the through-holes is from 0.2 mm to 3 mm, the aesthetic appearance of the plurality of through-holes can be enhanced, and high air permeability can be maintained.

The air permeability may be not less than 10 (cm³/cm²·s). As a result, high air permeability, for example, can be maintained.

The tensile stress at 150% elongation for a second time may be not greater than 2 N/25 mm. As a result, a clothing article, for example, can be easily stretched when the clothing article is worn on the body.

The return stress at 250% elongation for a second time may be not less than 0.2 N. As a result, mechanical properties suited to fitting the body after being worn on the body, for example, can be achieved.

The elongation rate when stretched in at least one direction may be not less than 150%. As a result, a high elongation rate can be maintained in a state in which a plurality of through-holes are formed, for example.

The tensile strength when stretched in at least one direction may be not less than 1 N/25 mm. As a result, a high tensile strength can be maintained in a state in which a plurality of through-holes are formed, for example.

The stretchable member according to one aspect of the present disclosure includes: a stretchable part having a structure in which the skin layer of the stretchable material described above is plastically deformed; and a shape retaining part that maintains the layer structure of the stretchable material. Since this stretchable member includes the stretchable material described above, the same operation and effects as those of the stretchable material described above can be achieved. In addition, when this stretchable member is applied to a clothing article, the stretchable part will elongate during wearing, and the shape of the shape retaining part is maintained. Therefore, the stretchable member can provide favorable joining properties to other members by joining to other members in the shape retaining part.

The black/white contrast difference between portions other than the through-holes in the stretchable part and a moisture-permeable polyethylene sheet of a diaper may be not less than 55. As a result, it becomes easy to confirm that the stretchable member has been positioned appropriately, for example.

The production method for a stretchable material according to one aspect of the present disclosure is a production method for a stretchable material including a core layer containing an elastomer; and a skin layer provided on a main surface of the core layer; the production method including forming a plurality of through-holes passing through the core layer and the skin layer such that a height of protrusions formed on the outer edges of the through-holes is not greater than 160 μm.

With the production method described above, a stretchable material exhibiting the same operation and effects as those of the stretchable material described above can be produced.

In the step described above, the plurality of through-holes may be formed by passing a plurality of heat needles through the core layer and the skin layer. In addition, in the step described above, the plurality of through-holes may be formed by die cutting. In this case, the height of protrusions formed on the outer edges of the through-holes can be suppressed more reliably, which further enhances the texture.

In the step described above, the stretchable material in which a plurality of through-holes are formed may be flattened at a temperature of not lower than 80° C. As a result, since the stretchable material is flattened at a high temperature, the height of protrusions can be suppressed even more reliably.

The production method for a stretchable member according to one aspect of the present disclosure includes elongating at least a portion of the stretchable material described above and plastically deforming at least a portion of the skin layer. With this production method, a stretchable member exhibiting the same operation and effects as those of the stretchable material and the stretchable member described above can be produced.

The clothing article according to one aspect of the present disclosure includes the stretchable material described above or the stretchable member described above. With this clothing article, the same operation and effects as those of the stretchable material and the stretchable member described above can be achieved.

The stretchable member according to another aspect of the present disclosure is a stretchable member including: a core layer containing an elastomer; and a skin layer provided on a main surface of the core layer, the skin layer being plastically deformed, the core layer containing no white master batch, and/or the skin layer being formed from a homopolyolefin, and a black/white contrast difference relative to a moisture-permeable polyethylene sheet being not less than 55. As a result, it becomes easy to confirm that the stretchable member has been positioned appropriately, for example.

### Effect of the Invention

According to one aspect of the present disclosure, the air permeability can be enhanced, and the texture can be improved.

### BRIEF DESCRIPTION OF THE DRAWINGS

FIG. 1 is a perspective view illustrating an example of a clothing article according to an embodiment.

FIG. 2 is a plan view illustrating an embodiment of a stretchable material that may be contained in the clothing article illustrated in FIG. 1.

FIG. 3 is a magnified cross-sectional view along line in FIG. 2.

FIG. 4 is a plan view of a stretchable material, wherein the plan view of FIG. 2 is magnified.

FIG. 5 is a plan view illustrating a through-hole of the stretchable material illustrated in FIG. 4.

FIG. 6A is a cross-sectional view illustrating the protrusion of the through-hole illustrated in FIG. 5. FIG. 6B is a cross-sectional view illustrating a protrusion after being flattened.

FIG. 7 is a side view illustrating an embodiment of a means for forming the through-hole illustrated in FIG. 5.

FIGS. 8A and 8B are drawings for describing an embodiment of the elongating process of the stretchable material.

FIG. 9 is a plan view illustrating an embodiment of the stretchable member.

FIG. 10 is a plan view illustrating through-holes of a form other than that illustrated in FIG. 5.

FIG. 11A is a drawing illustrating an example of the relationship between the elongation rate and the tensile stress in a stretchable material having staggered through-holes. FIG. 11B is a drawing illustrating an example of the relationship between the elongation rate and the tensile stress in a stretchable material having lattice-like through-holes.

### DESCRIPTION OF THE PREFERRED EMBODIMENTS

Embodiments of the stretchable material, the production method for a stretchable material, the stretchable member, the production method for a stretchable member, and the clothing article according to the present disclosure will be described hereinafter with reference to the drawings. In the descriptions of the drawings, the same reference symbols have been assigned to elements that are the same or equivalent, and redundant descriptions thereof have been omitted as necessary. Furthermore, the drawings are drawn with a portion simplified or embellished to ease understanding, and the dimensional ratios and the like are not limited to those illustrated in the drawings.

### Stretchable Material

The stretchable material according the present embodiment includes: a core layer containing an elastomer; and a skin layer having a tensile yield stress that is lower than that of the core layer. A stretchable member including a stretchable part is formed as a result of at least a portion of the skin layer being plastically deformed in the elongation process. When forming the stretchable member, a portion where the layer structure of the stretchable material is maintained (shape retaining part) may be provided by plastically deforming a portion of the skin layer. The stretchable member having a shape retaining part maintains favorable joining properties with other members in the shape retaining part.

The stretchable material may have a layer structure (skin layer/core layers/skin layer) wherein skin layers are provided on both main surfaces of the core layer. With this stretchable material, the tensile stress on both main surface sides will be more uniform, and warping or the like due to nonuniform shrinking is prevented. With this stretchable material, the skin layers are mutually in contact when wound in a roll form. Such contact prevents blocking between the stretchable members (for example, between the skin layer and the core layer), and thus the workability when unwinding and the storage stability of the stretchable material will be favorable. Note that the layer structure of the stretchable material is not limited to the structure described above, and the stretchable material may have, for example, a layer structure (core layer/skin layer) in which a skin layer is laminated on only one surface side of the core layer.

The core layer and the skin layer may be directly bonded, or may be indirectly bonded with a middle layer sandwiched therebetween. The middle layer may be, for example, a decorative layer containing a colorant, or an adhesive layer that joins the core layer and the skin layer to one another. The bonding condition of the core layer and the skin layer is not particularly limited, and for example, the resins that form the core layer and the skin layer may be fused together, or may be bonded by an adhesive layer interposed between the core layer and the skin layer.

The thickness of the core layer and the thickness of the skin layer are not particularly limited, but the thickness of the core layer may be greater than or equal to the thickness of the skin layer. In this case, necking of the stretchable part during elongation is more reliably suppressed. Since necking during elongation can be made small, the localized action of the tightening force is prevented, and excellent comfort can be achieved when worn. In addition, when the skin layer has a microphase separation structure as described below, necking can be more reliably suppressed and the comfort can be further enhanced when worn because the core layer is thicker than the skin layer. Furthermore, with a stretchable material in which the skin layer has a microphase separation structure, the elongation tends to be more uniform at the time of elongation.

In this embodiment, the ratio of the thickness of the skin layer to the thickness of the core layer may be from 0.1 to 1, or may be from 0.2 to 0.5. In this case, necking during elongation is more reliably suppressed. Note that when a plurality of skin layers are laminated in the stretchable material, the “thickness of the skin layer” refers to the total thickness of the skin layers. Furthermore, when a plurality of core layers are laminated in the stretchable material, the “thickness of the core layer” refers to the total thickness of the core layers.

In the present embodiment, the tensile stress of the stretchable material in at least one direction at 300% elongation may be 110% or less of the tensile yield stress of the skin layer in that direction. When the tensile stress at 300% elongation is 110% or less of the tensile yield stress of the skin layer, the shape retaining member can maintain the original shape even when the elongation is approximately 200%, which is a level for practical use. Therefore, the joining properties to other members will be more favorable, which enables greater repeated use.

Note that in the present embodiment, the tensile stress of the elastic material at 300% elongation is measured in accordance with JIS K 7127 where the test piece width is 25 mm, the chuck interval is 50 mm, and the test speed is 300 mm/minute. Note that when the elastic material has a plurality of skin layers, the maximum tensile yield stress of each skin layer is referred to as the “tensile yield stress of the skin layer”. The tensile yield stress of the skin layer may be measured by peeling off the skin layer from the elastic material, or may be measured using a test piece that is equivalent to the skin layer. As a simple method, during the tensile stress test of the stretchable material, the yield point where all of the skin layers are plastically deformed can be regarded as the tensile yield stress of the skin layer.

In the present embodiment, the stretchable material has a shrinkage ratio in the width direction that is orthogonal to the elongation direction at 200% elongation in at least one direction (ratio of the width that has contracted due to elongation, with regard to the width prior to elongation) may be 30% or less, preferably 25% or less, more preferably 15% or less, and even more preferably 10% or less.

When the stretchable member has a stretchable part and a shape retaining part, the width of the shape retaining part will be maintained at a constant width, and the stretchable part will experience necking along with elongation. With the stretchable material, the shrinkage ratio in the width direction that is orthogonal to the elongation direction is 30% or less at 200% elongation, to the degree of necking of the stretchable part will be sufficiently small during elongation, and the wearing properties and the comfort while wearing can be sufficiently ensured. With this stretchable material, a stretchable part may be formed by elongating in a direction where the shrinkage ratio is within the aforementioned range.

Note that with the present embodiment, the shrinkage ratio in the width direction that is perpendicular to the elongation direction at 200% elongation is expressed as the value measured by the following method. First, a rectangular test piece (width 50 mm, length 50 mm or longer) is prepared having a long side and a short side along the elongation direction and the width direction. Both end of the test piece in the elongation direction are clamped such that the length of the elongation portion is 50 mm, and then the test piece is elongated 200% in the elongation direction. When the initial width of the test piece is L2 and the minimum width of the test piece at 200% elongation is L1, the shrinkage ratio (%) is calculated by (L2−L1/L21)×100.

Next, each layer that forms the stretchable material in the present embodiment will be described.

### Core Layer

The stretchable material of the present embodiment includes a core layer containing an elastomer. The core layer is a layer responsible for the elastic function of the stretchable member, and the composition thereof may be selected to have the desired rubber elasticity. The elastomer that is included in the core layer is a material having rubber elasticity, and the core layer has a tensile stress that is 10% lower than that of the skin layer, for example. In the present embodiment, the 10% tensile stress is also referred to as the 10% modulus, and is the force per unit area required for elongating 10%, which is measured in accordance with JIS K 6251.

The 10% tensile stress of the core layer may be, for example, not greater than 0.5 MPa, not greater than 0.3 MPa, or not greater than 0.1 MPa. Therefore, a stretchable member having excellent handling properties may be obtained because the stretchable member conforms and elongates even with a small stress. In addition, the core layer may have a 300% tensile stress within the aforementioned range in at least one direction. Note that the core layer may have a 300% tensile stress within the aforementioned range in the elongation direction of the stretchable material.

The thickness T1 of the core layer may be, for example, 10 μm or greater, and is preferably 15 μm or greater. The thickness T1 of the core layer can be, for example, 100 μm or less, or can be 50 μm or less, or can be 35 μm or less, from the perspective of achieving sufficient effects and reducing material cost.

The core layer may be made of a resin material containing an elastomer (hereinafter also referred to as “resin material (A)”). Examples of the type of elastomer include styrene-isoprene-styrene block copolymer (SIS), styrene-butadiene-styrene block copolymer (SBS), styrene-ethylene/butylene-styrene block copolymer (SEBS), styrene butadiene rubber, hydrogenated or partially hydrogenated SIS, hydrogenated or partially hydrogenated SBS, polyurethane, ethylene copolymer (for example, ethylene-vinyl acetate, ethylene-propylene copolymer, ethylene-propylene-diene terpolymer), propylene oxide (PO), and the like.

The resin material (A) may contain other components besides the aforementioned components. For example, the resin material (A) may also contain a stiffening agent (for example, polyvinyl styrene, polystyrene, polyα-methyl styrene, polyester, epoxy resin, polyolefin, coumarone-indene resin), viscosity reducing agent, plasticizer, tackifier (for example, aliphatic hydrocarbon tackifier, an aromatic hydrocarbon tackifier, a terpene resin tackifier, a hydrogenated terpene resin tackifier), dye, pigment, antioxidant, antistatic agent, adhesive, antiblocking agent, slip agent, heat stabilizer, light stabilizer, blowing agent, glass bubbles, starch, metal salt, and microfibers.

### Skin Layer

The skin layer according to the present embodiment has, for example, a tensile stress that is 10% higher than that of the core layer in at least one direction. The skin layer has a function of protecting the core layer, and plastically deforms by an elongation process when manufacturing the stretchable member. At this time, the core layer is elastically deformed, and the skin layer is plastically deformed. As a result, the elongation portion can be used as the stretchable part of the stretchable member. In addition, the skin layer may have a function of maintaining the shape of the shape retaining part in the stretchable member.

The 10% tensile stress of the skin layer can be, for example, 1 MPa or greater, or can be 2 MPa or greater. Therefore, deformation will not occur under a small tensile stress, and the handling properties of the stretchable material will be favorable. Furthermore, the 10% tensile stress of the skin layer can be, for example, 15 MPa or less, or can be 10 MPa or less. Therefore, the stress which plastically deforms the skin layer can be reduced, and the processability is enhanced.

In addition, the skin layer may have a 10% tensile stress within the aforementioned range in at least one direction. The skin layer may have a 10% tensile stress within the aforementioned range in the elongation direction of the stretchable material. Incidentally, with the present embodiment, the 10% tensile stress of the skin layer is measured in accordance with JIS K 6251.

The tensile yield stress of the skin layer may be, for example, 2 N/25 mm or greater, preferably 2.5 N/25 mm or greater, and more preferably 3 N/25 mm or greater. Furthermore, the tensile yield stress of the skin layer can be, for example, 10 N/25 mm or less, and preferably 7 N/25 mm or less.

Note that the skin layer may have a tensile yield stress within the aforementioned range in at least one direction. Furthermore, the skin layer may have a tensile yield stress within the aforementioned range in the elongation direction of the stretchable material. Furthermore, the tensile yield stress of the skin layer is measured in accordance with JIS K 7127 where the test piece width is 25 mm, the chuck interval is 50 mm, and the test speed is 300 mm/minute.

The tensile yield strain of the skin layer may be, for example, 20% or less, and preferably 15% mm or less. Note that the skin layer may have a tensile yield strain within the aforementioned range in at least one direction. Furthermore, the skin layer may have a tensile yield strain within the aforementioned range in the elongation direction of the stretchable material. In the present embodiment, the tensile yield strain of the skin layer is measured in accordance with JIS K 7127.

The thickness T2 of the skin layer may be, for example, 2 μm or greater, and preferably 5 μm or greater, from the perspective that the aforementioned preferable tensile properties may be easily achieved, and manufacturing will be easy. Furthermore, the thickness T2 of the skin layer may be, for example, 30 μm or less, preferably 20 μm or less, from the perspective of further reducing strain of the stretchable part when the elongated condition is maintained for a long period of time.

In one form, the resin material used to form the skin layer (hereinafter also referred to as “resin material (B)”) may form a microphase separation structure. With this skin layer, uniform plastic deformation can occur due to the elongating process because a phase structure that readily plastically deforms is precisely distributed along the entire skin layer. Therefore, the stretchable part that is obtained will have excellent elongation uniformity when elongating. Furthermore, when the skin layer has a microphase separation structure, necking can be more remarkably suppressed when elongating, and a stretchable member with even better comfort while wearing can be achieved.

Furthermore, when the skin layer described above is used, the elongation will be uniform even when the degree of elongating is relatively low at 100% elongation or the like, and therefore an elongating process of the stretchable material can be performed to any degree of elongating such as 100%, 150%, 200%, 250%, 300%, and the like. Note that in a case where the degree of elongating during the elongating process is different, the elasticity of the stretchable part that is formed and the mechanical properties such as tensile stress and the like will change. In other words, with this embodiment, elastic parts having different properties can be formed from the same elastic material by changing the degree of elongating during the elongating process. Therefore, even when the required properties vary depending on the region of the clothing article, the same stretchable material can be used in the regions by adjusting the degree of elongating corresponding to the desired properties.

The microphase separation structure formed by the resin material (B) may be, for example, a lamellar structure, gyroid structure, cylinder structure, or BCC structure. The microphase separation structure may be formed, for example, from a block copolymer, or may be formed from a polymer blend.

The resin material (B) may contain a block copolymer. The block copolymer is preferably a block copolymer that forms a microphase separation structure. The block copolymer may contain as elements, for example, olefin type elements such as ethylene, propylene, and butylene, ester type elements such as ethylene terephthalate, or styrene type elements such as styrene.

The resin material (B) may form a microphase separation structure by a polymer blend that contains two or more polymers. Examples of the polymers that are included in the resin material (B) include polypropylene, polyethylene, polybutylene, polyethylene terephthalate, and polystyrene.

In another form, the resin material (B) does not form a microphase separation structure, but may form a uniform layer structure. Therefore, the strain due to wearing for a long period of time can be remarkably suppressed in the stretchable part of the stretchable member. Furthermore, the strain due to the aforementioned elongation test can easily be suppressed within a preferable range of 25% or less when the skin layer has a uniform layer structure. In other words, with the present form, the strain of the stretchable part due to wearing for a long period of time can be further suppressed as compared to the case where the resin material (B) forms in microphase separation structure, and excellent fit can be maintained for a longer period of time.

The resin material (B) may contain a homopolymer. By using a resin material (B) containing a homopolymer, a skin layer having the aforementioned uniform layer structure can easily be obtained.

Examples of homopolymers include polypropylene, and polyethylene, polybutylene.

The resin material (B) may contain other components besides the aforementioned components. For example, the resin material may contain a mineral oil extender, antistatic agent, pigment, dye, anti-adhesive agent, starch, metal salt, and stabilizer.

The method of manufacturing the stretchable material according to the present embodiment is not particularly limited, and for example, standard multilayer film forming technology that uses resin materials can be used.

With the shrinkable material according the present embodiment, the core layer and the skin layer may be integrally formed by simultaneously extrusion molding the resin material (A) that forms the core layer and the resin material (B) that forms the skin layer. The conditions for simultaneous extrusion molding may be appropriately adjusted depending on the composition and the like of the resin material (A) and the resin material (B). Furthermore, the stretchable material of the present embodiment may be manufactured by forming layer A containing the resin material (A) and layer B containing the resin material (B), and then laminating layer A and layer B.

### Stretchable Member

The stretchable member according to the present embodiment, can have a stretchable part (also referred to as an activating part) having a structure where the skin layer of the stretchable material is plastically deformed. Furthermore, the stretchable member according to the present embodiment may have a shape retaining part (non-activating part) that maintains the layer structure of the stretchable material.

The stretchable member according the present embodiment has a stretchable part that functions as a rubber elastic body, and therefore can be preferably used as an elastic web that is used in clothing articles and the like. Furthermore, the stretchable member according to the present embodiment can provide favorable joining properties to other members by joining to other members in the shape retaining part.

Furthermore, when elongation of the stretchable member is not uniform during elongation, the wearing properties and the comfort while wearing may be impaired. With a form where the skin layer has a microphase separation structure according to the present embodiment, the stretchable part will have excellent elongation uniformity.

Furthermore, when the width of the stretchable part during elongation is small particularly when the stretchable member is applied to a clothing article that is in close contact with the skin, the tightening force tends to act locally, and the comfort while wearing may be impaired. With a form where the skin layer has a microphase separation structure according to the present embodiment, the degree of necking of the stretchable part during elongation is sufficiently reduced, and the wearability and the comfort while wearing can be sufficiently ensured.

Furthermore, with the stretchable member, deformation or the like due to repeated use is also a problem when applied to clothing articles. The stretchable member of the present embodiment is formed from the aforementioned stretchable material, and therefore the shape retaining part can maintain the original shape even when repeatedly used, and favorable joining properties to other members can be maintained.

The stretchable part has a structure where the skin layer of the stretchable material is plastically deformed. In other words, the stretchable part may include a core layer and a skin layer that plastically deforms. In the stretchable part, the skin layer that has plastically deformed may be present as a single continuous layer, or may be a layer separated by elongation.

The shape retaining part has a layer structure of the stretchable material. In other words, the shape retaining part may include a core layer and a skin layer. The shape retaining part can also be referred to as the non-elongating part of the stretchable material.

The stretchable member is manufactured by performing an elongating process on the stretchable material based on the application of use. The application of the stretchable member is not particularly limited, and the stretchable member may be used, for example, in clothing applications. More specifically, the elastic member can be used, for example, as disposable diapers, adult incontinence pads, shower caps, surgical gowns, hats and boots, disposable pajamas, competition shoulder pads, clothes for clean rooms, head bands or visors for hats, ankle bands, wristbands, rubber pants, or wet suits.

The method of manufacturing the stretchable member may include a step of elongating at least a portion of the stretchable material, and plastically deforming at least a portion of the skin layer (also referred to as a step of activating at least a portion of the stretchable material). The stretchable part is formed by elongating the stretchable material until the skin layer is plastically deformed. Plastic deformation generally involves elongating still as to exceed the tensile yield strain of the skin layer.

With the method of manufacturing the elastic member, the shape retaining part and the stretchable part can be formed by plastically deforming only a portion of the skin layer.

The method of elongating the stretchable material is not particularly limited. For example, the stretchable member including two shape retaining parts with a predetermined width (sandwiched non-elongated portion) and a stretchable part that is formed between the shape retaining parts can be formed by clamping both ends of the stretchable material and elongating.

The temperature conditions when elongating the stretchable material are not particularly limited, and room temperature is acceptable. The elongation factor of the stretchable material needs only to be not less than the tensile yield strain of the skin layer, and may be at or above practically assumed elongation factors. Furthermore, the mechanical properties of the stretchable part can be changed by the elongation factor, and therefore the elongation factor can be determined based on the desired properties.

The clothing article includes the stretchable material or the stretchable member described above. The clothing article can be used, for example, as disposable diapers (open-type, underwear-type), adult incontinence pads, shower caps, surgical gowns, hats and boots, disposable pajamas, competition shoulder pads, clothes for clean rooms, head bands or visors for hats, ankle bands, wristbands, rubber pants, or wet suits.

A form of the present embodiment is described below with reference to the drawings. Note that the present disclosure is not limited to the form described below.

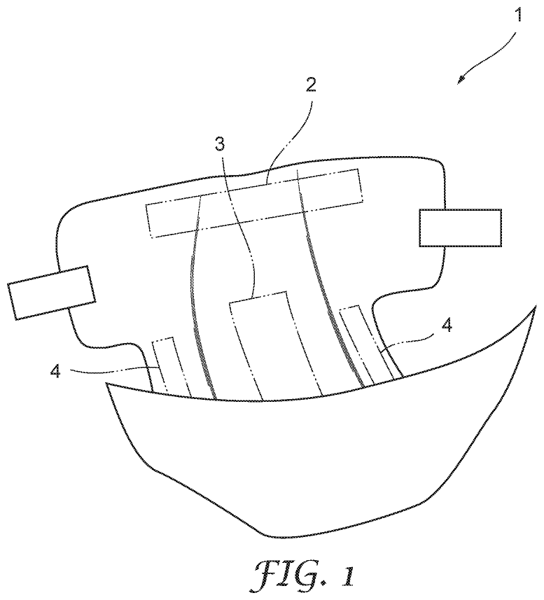

FIG. 1 is a perspective view illustrating an open-type (tape-type) diaper 1, which is a clothing article according to one embodiment. As illustrated in FIG. 1, the diaper 1 includes: a waist part 2 in contact with the waist, a crotch part 3 in contact with the crotch, and both side parts 4 positioned on both the left and right sides of the crotch part 3. The stretchable material and the stretchable member according to this embodiment can be applied to the waist part 2, the crotch part 3, or both side parts 4. In addition, the stretchable material and the stretchable member according to this embodiment can also be applied to the leg opening parts of a diaper, the leg gathers of a diaper, the outer parts of a diaper, or the like.

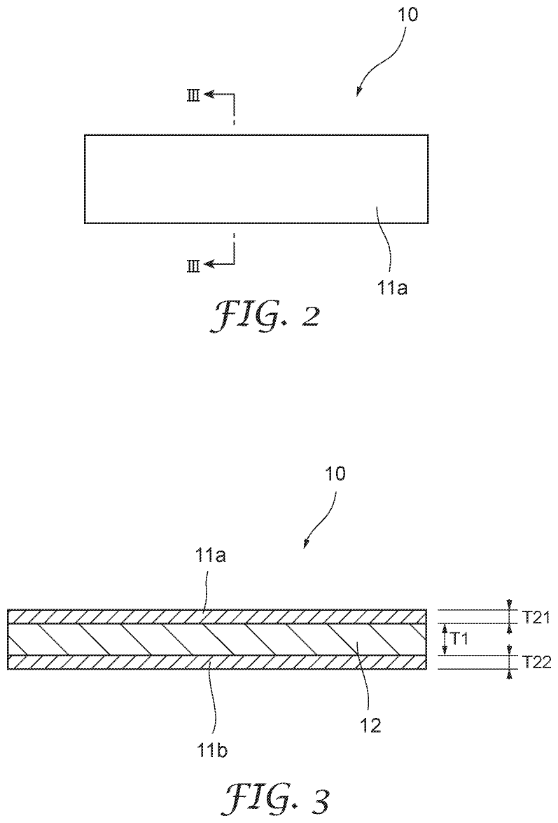

FIG. 2 is a plan view illustrating a stretchable material 10 according to one embodiment, and FIG. 3 is a cross-sectional view along line in FIG. 2. As illustrated in FIGS. 2 and 3, the stretchable material 10 has a rectangular shape in a plan view. The stretchable material 10 has a film shape extending in a planar manner. For example, a nonwoven fabric is laminated on both main surfaces of the stretchable material 10 for use in the diaper 1.

The stretchable material 10 includes a core layer 12 and skin layers 11a and 11b provided on each of the main surfaces of the core layer 12. The core layer 12 and the skin layers 11a and 11b both have a sheet shape, and the skin layers 11a and 11b protect each of the main surfaces of the core layer 12. Note that only one of the skin layers 11a and 11b may also be provided on one main surface of the core layer 12. The compositions of the resin materials constituting the skin layers 11a and 11b and the core layer 12 may be the same as or different from one another.

In the stretchable material 10, when the thickness of the core layer 12 is defined as T1, the thickness of the skin layer 11a is defined as T21, and the thickness of the skin layer 11b is defined as T22, the thickness T1 of the core layer 12 may be not less than the total thickness T21+T22 of the skin layers 11a and 11b. The thickness T2 of the skin layers described above corresponds to the sum of the thickness T21 of the skin layer 11a and the thickness T22 of the skin layer 11b. The ratio of the thickness T21+T22 (thickness T2) to the thickness T1 is, for example, from 0.1 to 1.

In the stretchable material 10, the core layer 12 may be formed from a rein material containing a branched polymer. The skin layers 11a and 11b may be formed from a resin material containing a homopolymer. In this case, the stretchable part formed from the stretchable material 10 will have minimal strain even when the elongation state is maintained for a long period of time, and excellent fit can be maintained for a long period of time when applied to a clothing article such as a diaper 1.

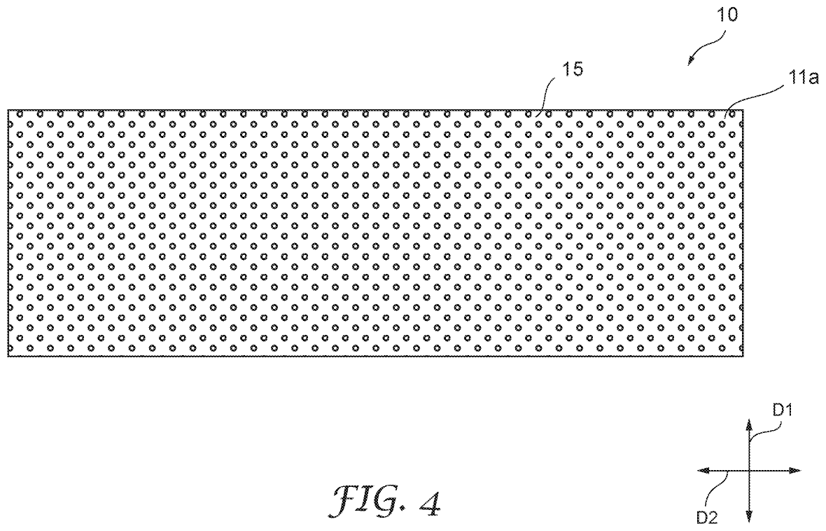

FIG. 4 is a magnified plan view of the stretchable material 10. As illustrated in FIG. 4, the stretchable material 10 has a rectangular shape including long sides which extend in the longitudinal direction D2 thereof and short sides which extend in the width direction D1. The width direction D1 corresponds to the conveying direction (MD: Machine Direction) in which the stretchable material 10 is conveyed, and the longitudinal direction D2 corresponds to a direction orthogonal to the conveying direction of the stretchable material 10 (CD: Cross Direction).

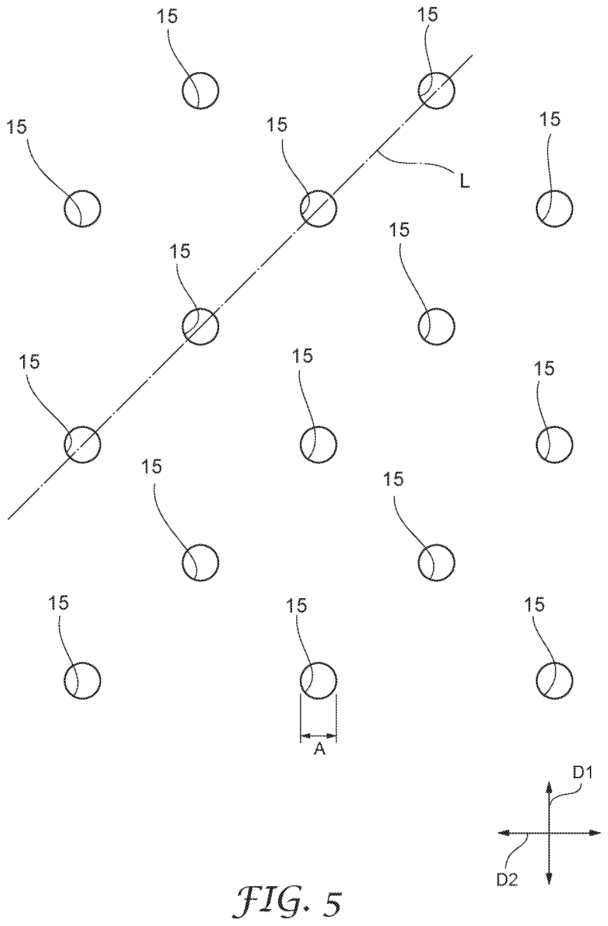

FIG. 5 is a plan view of the stretchable material 10, wherein the plan view of FIG. 4 is magnified. As illustrated in FIGS. 4 and 5, the stretchable material 10 includes a plurality of through-holes 15 which pass through the skin layers 11a and 11b and the core layer 12. As one example, the plurality of through-holes 15 are arranged in a staggered manner. Here, “the through-holes are arranged in a staggered manner” means that the through-holes are arranged so that an imaginary line L connecting one through-hole and another through-hole closest to the first through-hole is inclined with respect to the width direction D1 and the longitudinal direction D2.

As one example, the plurality of through-holes 15 are arranged substantially uniformly in the stretchable material 10. “The plurality of through-holes are arranged substantially uniformly” includes, for example, a state in which the plurality of through-holes are arranged to be symmetrical with one another with respect to a prescribed point or line, or a state in which the plurality of through-holes are dispersed concentrically. As a result of being dispersed substantially uniformly, there is an effect that the strength becomes uniform, for example. In addition, the through-holes may be arranged all over the entire stretchable material or may be arranged locally at specific sites of the stretchable material. When the through-holes are arranged locally, there is an effect that the air permeability or strength at appropriate positions can be controlled in accordance with the clothing article, for example. In this way, the manner in which the through-holes are arranged may be varied as necessary.

In one mode, the angle formed by the line L and the longitudinal direction D2 and the angle formed by the line L and the width direction D1 are 45°. However, this angle may be varied as necessary. The proportion of the area occupied by the plurality of through-holes 15 with respect to the stretchable material 10 is, for example, from 0.5% to 30%, preferably from 1% to 20%, and more preferably from 5% to 20%.

The shape of the through-holes 15 is circular, for example, but may also be semicircular, semi-elliptical, fan-shaped, square, triangular, or other polygonal shape and may be varied as necessary. In this specification, “the through-holes are circular” includes cases in which the through-holes are circular, cases in which the through-holes are oval, and cases in which the through-holes are elliptical. This refers to cases in which the shape of the through-holes does not have any angular portions. When the through-holes 15 are circular in this way, there are no angular portions which are easily broken in the through-holes 15. Thus, the strength of the through-holes 15 can be increased.

When the through-holes 15 are circular, the diameter A of the through-holes 15 is, for example, from 0.2 mm to 3 mm, preferably from 0.3 mm to 2 mm, and more preferably from 0.5 mm to 1 mm. Here, the “diameter of the through-holes” is the diameter when the shape of the through-holes is circular, but when the shape of the through-holes is oval or elliptical, this refers to at least either the major axis or the minor axis.

Since the through-holes 15 are more easily formed when the diameter A of the through-holes 15 is large, there is an advantage that the manufacturability of the stretchable material 10 is high. In addition, when the diameter A is from 0.3 mm to 2 mm, the design properties and aesthetic appearance of the arrangement of the through-holes 15 can be enhanced. When the diameter A is from 0.5 mm to 1 mm, the above effect is even more marked.

The air permeability of the stretchable material 10 including a plurality of through-holes 15 is, for example, not less than 10 (cm³/cm²·s), preferably not less than 20 (cm³/cm²·s), more preferably not less than 50 (cm³/cm²·s), even more preferably not less than 65 (cm³/cm²·s), and most preferably not less than 80 (cm³/cm²·s).

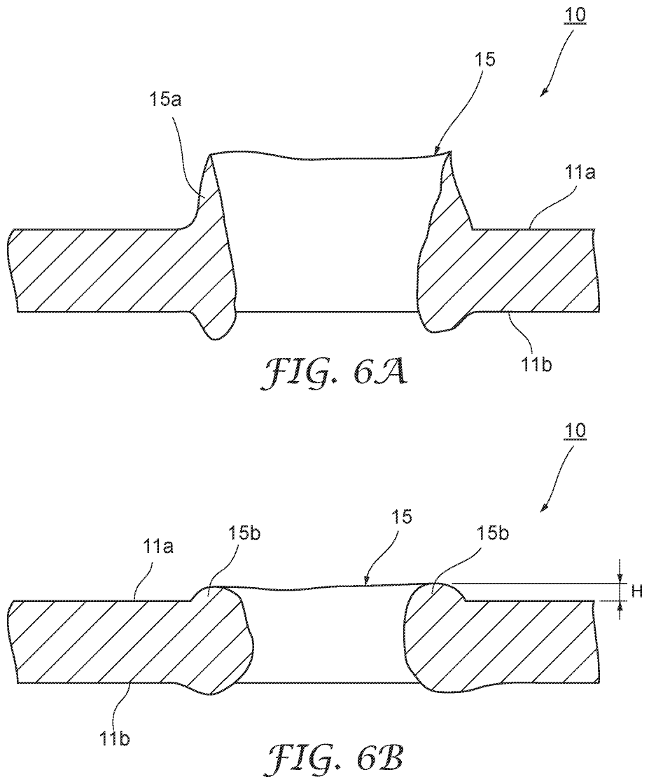

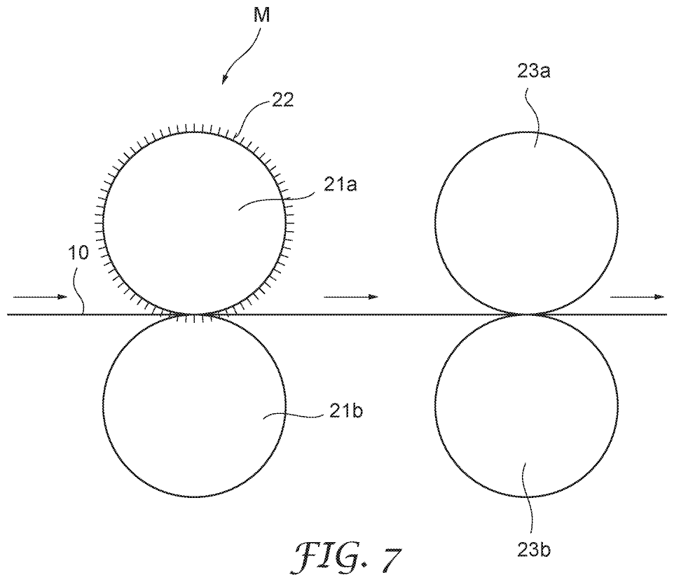

FIGS. 6A and 6B illustrate vertical cross-sectional views of a through-hole 15. FIG. 7 is a drawing illustrating an example of a production device for a stretchable material 10 including a plurality of through-holes 15. The production device M illustrated in FIG. 7 includes a first roll 21a provided with a heat needle 22, and a second roll 21b pressed into the first roll 21a. In the production method for the stretchable material 10 according to one embodiment, the stretchable material 10 is conveyed while being sandwiched between the first roll 21a and the second roll 21b, and the heat needle 22 passes through the stretchable material 10 to form a plurality of through-holes 15. In addition, the plurality of through-holes 15 may also be formed by die cutting, which involves a relatively small amount of burrs 15a. Further, as another means of forming through-holes, a plurality of through-holes 15 may be formed by a laser, ultrasonic waves, local aspiration, or the like.

FIG. 6A illustrates the through-hole 15 immediately after the heat needle 22 is passed through the stretchable material 10. As illustrated in FIG. 6A, when the heat needle 22 is inserted into and removed from the stretchable material 10, in particular, when the heat needle 22 is removed from the stretchable material 10, the portion of the stretchable material 10 along the outer edge of the through-hole 15 is pulled by the heat needle 22. A burr 15a protruding in the out-plane direction of the stretchable material 10 is formed on the outer edge of the through-hole 15. The burr 15a has a ring shape positioned on the outer periphery of the through-hole 15 in a plan view.

After the heat needle 22 is passed through the stretchable material 10 to form the through-hole 15, the stretchable material 10 may be flattened. In this case, the stretchable material 10 in which the through-holes 15 are formed is flattened at a temperature of not lower than 80° C. As an example, the stretchable material 10 is flattened by sandwiching the stretchable material 10 between two rolls 23a and 23b and conveying the stretchable material 10 with heating. In addition, the stretchable material 10 may be flattened by pressing the material with a plate or may be flattened by shaving. Rolls 23a and 23b are preferably used from the perspective of the production process.

FIG. 6B illustrates a through-hole 15 after the stretchable material 10 on which the burr 15a is formed is subjected to a flattening process. In this flattening process, the stretchable material 10 is heated and melted to form a flat shape. Therefore, the height of the protrusion 15b on the outer edge of the through-hole 15 is lower than the height of the burr 15a. As in the case of the burr 15a, the protrusion 15b has a ring-like planar shape.

When the height of the protrusion 15b formed on the outer edge of the through-hole 15 is defined as H, the height H is, for example, not greater than 160 μm or not greater than 100 μm and is preferably not greater than 50 μm. Here, the “height of the protrusion” refers to the height of the peak of the protrusion with respect to the main surface of the stretchable material (for example, the surfaces of the skin layers 11a and 11b).

The stretchable material 10 forms a stretchable member when elongated in the lengthwise direction D2, for example. The elongation rate of the stretchable material 10 when elongated in at least one direction (for example, the longitudinal direction D2) is, for example, not less than 150%, preferably not less than 200%, more preferably not less than 400%, and even more preferably not less than 500%. The tensile strength of the stretchable material 10 when elongated in at least one direction is, for example, not less than 1 N/25 mm, preferably not less than 3 N/25 mm, more preferably not less than 5 N/25 mm, and even more preferably not less than 7 N/25 mm.

The tensile yield stresses of the skin layer 11a and 11b in one direction are, for example, substantially equal to one another. When the stretchable material 10 is elongated in one direction, the skin layer 11a and 11b are plastically deformed, and a stretchable part is formed. The tensile stress at 300% elongation in the longitudinal direction D2 of the stretchable material 10 is, for example, 110% or less of the tensile yield stress of the skin layer 11a and the tensile yield stress of the skin layer 11b. Therefore, the shape retaining member can maintain the original shape even when the elongation is approximately 200%, which is a level for practical use, as described below, and therefore favorable joining properties to other members will be maintained.

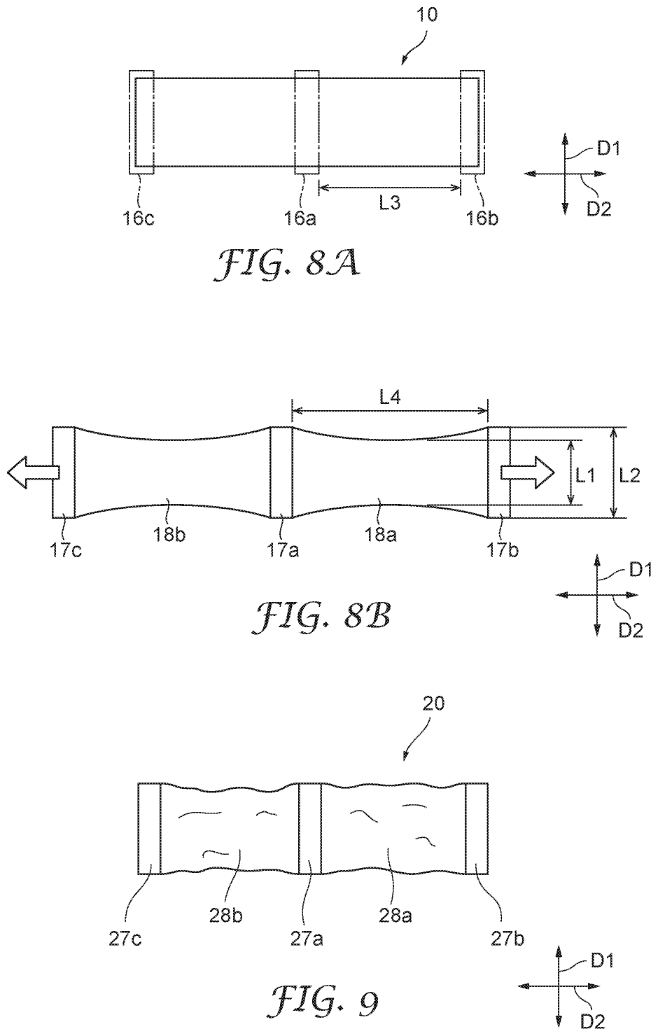

FIG. 8A and FIG. 8B are drawings for describing an embodiment of the elongating process of the stretchable material 10. In this embodiment, the elastic material 10 is sandwiched by sandwiching members in a region 16a of a center part in the longitudinal direction D2 of the elastic material 10 and in regions 16b and 16c at both ends. The area between the regions 16a and 16b and the area between the regions 16a and 16c are elongated by fixing the region 16a and pulling the regions 16b and 16c in the longitudinal direction D2. The through-holes 15 may or may not be formed in the regions 16a, 16b, and 16c.

FIG. 8A illustrates the stretchable material at the time of elongation. As illustrated in FIG. 8A, shape retaining parts 17a, 17b, and 17c are respectively formed in the regions 16a, 16b, and 16c sandwiched by the sandwiching members. The shape retaining parts 17a, 17b, and 17c are sites where the shape of the stretchable material 10 is maintained.

On the other hand, the area between the regions 16a and 16b and the area between the regions 16a and 16c are respectively elongated parts 18a and 18b. The elongated parts 18a and 18b correspond to the elongated sites of the stretchable material 10. In the elongated parts 18a and 18b, the skin layers 11a and 11b of the stretchable material 10 are plastically deformed.

Here, the shrinkage ratio in the width direction D1 when elongated by 200% in the longitudinal direction D2 is measured. The “shrinkage ratio” refers to the ratio of the shrunken width to the width L2 prior to elongation (L2−L1), that is, the ratio of a value determined by subtracting the minimum width L1 at the time of elongation from the width L2 prior to elongation ((L2−L1)/L2). Furthermore, “at 200% elongation” indicates that the length L4 when elongated is 200% compared to the initial length L3 of the portion to be elongated.

FIG. 9 is a plan view illustrating a stretchable member 20 according to one embodiment. The stretchable member 20 includes shape retaining parts 27a, 27b, and 27c, wherein the layer structure of the stretchable material 10 is maintained, and stretchable parts 28a and 28b that are formed between the shape retaining parts 27a, 27b, and 27c. When the stretchable member 20 is elongated in the longitudinal direction D2, the stretchable parts 28a and 28b are elongated, and the respective shapes of the shape retaining parts 27a, 27b, and 27c are maintained. Therefore, the stretchable member 20 can provide favorable adhering properties to other members by joining to other members with the shape retaining parts 27a, 27b, and 27c.

Incidentally, when through-holes 15 are formed in the regions 16a, 16b, and 16c sandwiched by the sandwiching members described above, the through-holes 15 are formed in the shape retaining parts 27a, 27b, and 27c and the stretchable parts 28a and 28b of the stretchable member 20. On the other hand, when through-holes 15 are not formed in the regions 16a, 16b, and 16c, the through-holes 15 are formed in the stretchable parts 28a and 28b of the stretchable member 20 but are not formed in the shape retaining parts 27a, 27b, and 27c.

From the perspective of manufacturability, the through-holes 15 are preferably formed in the shape retaining parts 27a, 27b, and 27c and the stretchable parts 28a and 28b because all of the through-holes 15 can be formed at once at all of the sites. However, from the perspective of adhesion to other members, the through-holes 15 are preferably not formed in the shape retaining parts 27a, 27b, and 27c because the adhesion is further increased when there are fewer through-holes 15.

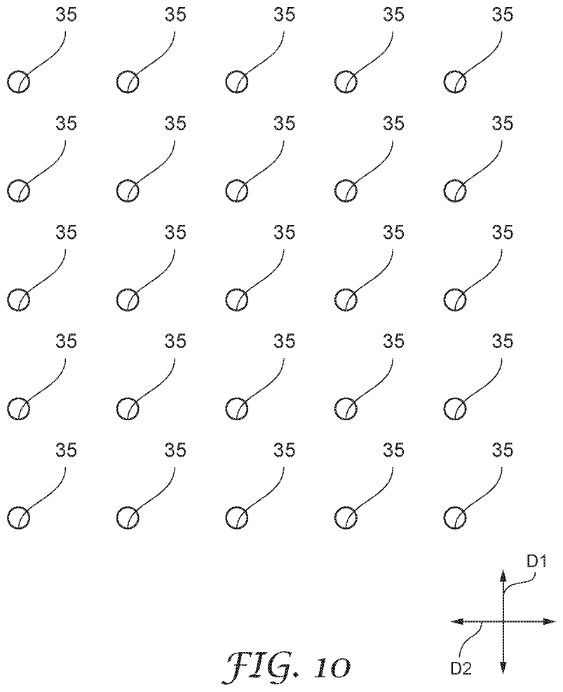

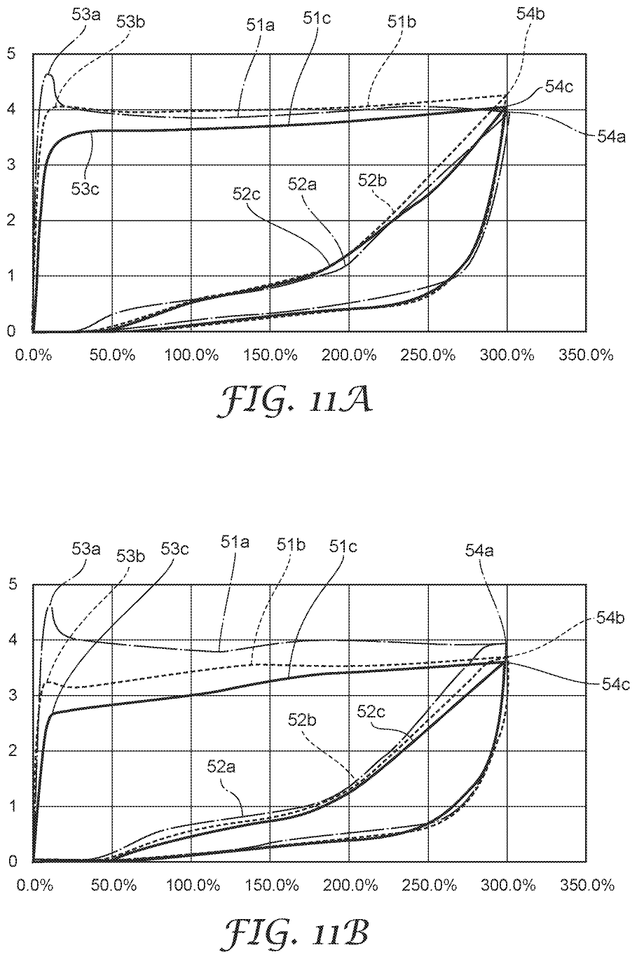

FIG. 10 is a plan view illustrating through-holes 35 of another form formed in the stretchable material. As illustrated in FIG. 10, the plurality of through-holes 35 are arranged in a lattice. Here, “the through-holes are arranged in a lattice” means that the through-holes are arranged such that an imaginary line connecting one through-hole and another through-hole closest to the first through-hole is aligned with the longitudinal direction D2 or the width direction D1.

FIG. 10 illustrates an example in which four mutually adjacent through-holes 35 form a square shape. When four mutually adjacent through-holes 35 form a square shape, the strength in the longitudinal direction D2 and the width direction D1 can be made uniform, which is preferable. However, the shape formed by the four mutually adjacent through-holes may also be another shape such as a rectangular shape. In this way, the manner in which the through-holes are arranged may be varied as necessary.

FIG. 11A illustrates an example of the relationship between the elongation ratio and the tensile stress of a stretchable material and a stretchable member having through-holes 15 arranged in a staggered manner. FIG. 11B illustrates an example of the relationship between the elongation ratio and the tensile stress of a stretchable material and a stretchable member having through-holes 35 arranged in a staggered manner.

In FIGS. 11A and 11B, line 51a shows the relationship between the elongation ratio and the tensile stress of the stretchable material at room temperature. Line 51b shows the relationship between the elongation ratio and the tensile stress of the stretchable material in a flattening process at 100° C. Line 51c shows the relationship between the elongation ratio and the tensile stress of the stretchable material in a flattening process at 120° C.

In FIGS. 11A and 11B, line 52a shows the relationship between the elongation ratio and the tensile stress when the stretchable member formed from the stretchable material elongated by 300% is elongated at room temperature. Line 52b shows the relationship between the elongation ratio and the tensile stress when the stretchable member formed from the stretchable material elongated by 300% is elongated at 100° C. Line 52c shows the relationship between the elongation ratio and the tensile stress when the stretchable member formed from the stretchable material elongated by 300% is elongated at 120° C.

In FIGS. 11A and 11B, points 53a, 53b, and 53c represent tensile yield points of the skin layers in each stretchable material, and the tensile stresses of the points 53a, 53b, and 53c correspond to the tensile yield stresses of the skin layers. Points 54a, 54b, and 54c are points indicating the tensile stresses of each stretchable material at 300% elongation. The tensile stresses at the points 54a, 54b, and 54c may be not greater than 110% of the tensile stresses at the points 53a, 53b, and 53c. In addition, prior to the plastic deformation of the skin layer, a stretchable material having through-holes with a staggered arrangement is resistant to elongation unless a strong force is applied, but a stretchable material having through-holes with a lattice arrangement tend to be elongated relatively easily with even a weak force.

Next, the operation and effects of the stretchable material, the production method for a stretchable material, the stretchable member, the production method for a stretchable member, and the clothing article according to embodiments will be described.

In the embodiments described above, a stretchable member 20 in which stretchable parts 28a and 28b are optionally formed can be obtained by elongating a portion of the stretchable material 10 and plastically deforming portions of the skin layers 11a and 11b. In addition, since the stretchable material 10 has a plurality of through-holes 15, the air permeability can be increased.

Further, since the height of the protrusions 15b formed on the outer edges of the through-holes 15 is not greater than 160 μm, the protrusions 15b can be prevented from penetrating into the through-holes 15 in subsequent processing. When the height of the protrusions 15b is not greater than 160 μm, the obstruction of the circulation of air near the through-holes 15 can be inhibited. Thus, high air permeability can be maintained.

In addition, when the height of the protrusions 15b is not greater than 160 μm, the texture can be enhanced when the stretchable material 10 is used in a clothing article such as a diaper 1. The height of the protrusions 15b may also be not greater than 100 μm. As a result, the air permeability can be maintained at high levels, and the texture can be further improved.

The proportion of the area occupied by the plurality of through-holes 15 with respect to the stretchable material 10 may also be from 1% to 20%. As a result, the air permeability of the stretchable material 10 and the strength of the stretchable material 10 can be more reliably maintained at high levels.

The air permeability of the stretchable material 10 may be not less than 10 (cm³/cm²·s). As a result, high air permeability can be maintained. The air permeability of the stretchable material 10 may also be not less than 25 (cm³/cm²·s). As a result, even higher air permeability can be maintained. The air permeability of the stretchable material 10 may also be not less than 50 (cm³/cm²·s). As a result, even higher air permeability can be maintained.

The elongation rate of the stretchable material 10 when stretched in at least one direction (for example, the longitudinal direction D2) may be not less than 150%. As a result, a high elongation rate can be maintained in a state in which a plurality of through-holes 15 are formed. The tensile strength of the stretchable material 10 when stretched in at least one direction may be not less than 1 N/25 mm. As a result, a high tensile strength can be maintained in a state in which a plurality of through-holes 15 are formed.

The plurality of through-holes 15 may be arranged in a staggered manner. As a result, the strength of the stretchable material 10 against pulling can be increased further. In addition, the plurality of through-holes 35 may be arranged in a lattice.

The through-holes 15 may have a circular shape, and the diameter A of the through-holes 15 may be from 0.2 mm to 3 mm. When the through-holes 15 have a circular shape, fracturing from the through-holes 15 can be inhibited. In addition, when the diameter A of the through-holes 15 is from 0.2 mm to 3 mm, the aesthetic appearance of the plurality of through-holes 15 can be enhanced because the plurality of through-holes 15 can be formed in a clean manner, and high air permeability can be reliably maintained.

The through-holes 15 may have a circular shape, and the diameter A of the through-holes 15 may be from 0.5 mm to 1 mm. As a result, the effect of the aesthetic appearance of the through-holes described above and the effect enabling the air permeability to be maintained are even more marked.

The production method for the stretchable material 10 is a production method for a stretchable material 10 including a core layer 12 containing an elastomer and skin layers 11a and 11b provided on the main surfaces of the core layer 12, the production method including forming a plurality of through-holes 15 passing through the core layer 12 and the skin layers 11a and 11b such that the height of protrusions 15b formed on the outer edges of the through-holes 15 is not greater than 160 μm. With the production method described above, a stretchable material exhibiting the same operation and effects as those described above can be produced.

In the step described above, the plurality of through-holes 15 may be formed by passing a plurality of heat needles 22 through the core layer 12 and the skin layers 11a and 11b. In addition, in the step described above, the plurality of through-holes 15 may be formed by die cutting. In this case, the height of protrusions 15b formed on the outer edges of the through-holes 15 can be suppressed more reliably.

In the step described above, the stretchable material 10 in which a plurality of through-holes 15 are formed may be flattened at a temperature of not lower than 80° C. As a result, since the stretchable material 10 is flattened at a high temperature, the height of the protrusions 15b can be suppressed even more reliably.

The stretchable member 20 includes stretchable parts 28a and 28b having a structure in which the skin layers 11a and 11b of the stretchable material 10 are plastically deformed, and shape retaining parts 27a, 27b, and 27c, wherein the layer structure of the stretchable material 10 is maintained. Since the stretchable member 20 includes the stretchable material 10, the same operation and effects as those of the stretchable material 10 can be achieved. In addition, when the stretchable member 20 is applied to a clothing article such as a diaper 1, the stretchable parts 28a and 28b will elongate during wearing, and the shapes of the shape retaining parts 27a, 27b, and 27c are maintained. Therefore, the stretchable member can provide favorable joining properties to other members by joining to other members in the shape retaining parts 27a, 27b, and 27c.

The production method for the stretchable member 20 includes elongating at least a portion of the stretchable member 20 and plastically deforming at least a portion of the skin layers 11a and 11b. With the production method described above, a stretchable member exhibiting the same operation and effects as those described above can be produced.

The diaper 1 includes the stretchable material 10 or the stretchable member 20. Therefore, with the diaper 1, the same operation and effects as those of the stretchable material 10 and the stretchable member 20 described above can be achieved.

In addition, when the stretchable material 10 or the stretchable member 20 is used for the crotch part 3 or the like of the diaper 1, the stretchable material 10 or the stretchable member 20 is placed on a moisture-permeable resin sheet. In this case, unless the stretchable material 10 or the stretchable member 20 cannot be discerned, it may not be possible to determine whether the stretchable material 10 or the stretchable member 20 has been placed properly. The moisture-permeable resin sheet typically has a matte quality similar to that of a nonwoven fabric. Therefore, it is even more preferable that the core layer 12 of the stretchable material 10 or the stretchable member 20 include no white master batch and a resin having a high-gloss quality be used for the skin layers 11a and 11b. By not including a white master batch in the core layer 12 of the stretchable material 10 or the stretchable member 20 and using a high-gloss resin for the skin layers 11a and 11b, the difference in contrast of the optical camera (in terms of black/white binary values, black is 0 and white is 255) can be made large. For example, the difference in contrast between a moisture-permeable polyethylene film of a commercially available diaper and a stretchable member in which the skin layers are plastically deformed (at locations other than the through-holes) is not less than 40, preferably not less than 55, and even more preferably not less than 70.

Although descriptions were given above for the preferred embodiments of the present disclosure, the present disclosure is not limited to the aforementioned embodiments.

### EXAMPLES

Next, examples of the stretchable material and the stretchable member will be described. The present disclosure is not limited to the examples described below. In experiments related to the examples, tensile tests were performed on the stretchable materials of Examples 1 to 6 described below and the stretchable materials of Comparative Examples 1 to 3. The air permeability, the size of the through-holes, the coefficient of friction, the tensile stress, and the elongation ratio were measured. Air permeability tests were performed in accordance with JIS L 1096. Friction tests (dynamic friction coefficient measurements) were performed in accordance with JIS K 7125. Tensile tests were performed in accordance with JIS K 7127 (test piece width: 25 mm, chuck interval: 50 mm, test speed: 300 mm/minute).

The following materials were commonly used as the materials of the examples and the comparative examples. A mixture containing 40 parts by mass of “Quintac 3620” (available from Zeon Corporation, styrene-isoprene-styrene block copolymer, a mixture of a straight chain polymer and a branched polymer), 56 parts by mass of “Quintac 3390” (available from Zeon Corporation, styrene-isoprene-styrene block copolymer, straight chain polymer), and 4 parts by mass of a styrene-isoprene-styrene block copolymer based white master batch containing 20% TiO₂ was used as the resin material that forms the core layer. Incidentally, the white master batch was added to provide a white color. “Novatec PP BC 2E” (available from Japan Polypropylene Corporation, ethylene propylene block copolymer) was used as the resin material that forms the skin layer. The skin layer:core layer:skin layer thickness ratio was 15:75:15 (the ratio of the thickness of the skin layers to the thickness of the core layer was 0.43). The total thickness of the three layers was approximately 37 μm.

Through-holes were formed in a staggered manner in the stretchable material of Example 1 using a heat needle (220° C., 30 mpm), and the material was then flattened with a roller at 120° C.

Through-holes were formed in a lattice in the stretchable material of Example 2 (needle specs: needle having a pitch of 1.5 mm×1.5 mm and an OD of 1.06), and the material was then flattened at 120° C. (calendering at 5 mpm).

Through-holes were formed in a staggered manner in the stretchable material of Example 3 (needle specs: needle having a pitch of 2.5 mm×2.5 mm and an OD of 0.62), and the material was then flattened at 100° C.

Through-holes were formed in a lattice in the stretchable material of Example 4, and the material was then flattened at 100° C.

Through-holes were formed in a staggered manner in the stretchable material of Example 5, and the material was then flattened at 80° C.

Through-holes were formed in a lattice in the stretchable material of Example 6, and the material was then flattened at 80° C.

A stretchable material having no through-holes was used as Comparative Example 1.

Through-holes were formed in a staggered manner in the stretchable material of Comparative Example 2, and the material was not flattened thereafter.

Through-holes were formed in a lattice in the stretchable material of Comparative Example 2, and the material was not flattened thereafter.

The results of tensile tests on Examples 1 to 6 and Comparative Examples 1 to 3 described above are as shown in Table 1 below. Note that in Table 1, a stretchable member used in a size M Moony Airfit available from the Unicharm Corporation was used as a “commercially available diaper”. In addition, “MD” refers to the conveying direction (MD: Machine Direction) in which the stretchable material is conveyed, and “CD” refers to a direction orthogonal to the conveying direction of the stretchable material (CD: Cross Direction).

TABLE 1

| | Example | Example | Example | Example | Example | Example | Comparative | Comparative | Comparative |
|---|---|---|---|---|---|---|---|---|---|
| | 1 | 2 | 3 | 4 | 5 | 6 | example 1 | example 2 | example 3 |
| Thickness of stretchable | 35 | 35 | 37 | 37 | 36 | 36 | 38 | 37 | 38 |
| material not including | | | | | | | | | |
| protrusions of | | | | | | | | | |
| through-holes (μm) | | | | | | | | | |
| Thickness of stretchable | 91 | 90 | 119 | 119 | 192 | 140 | 38 | 227 | 239 |
| material including | | | | | | | | | |
| protrusions of | | | | | | | | | |
| through-holes (μm) | | | | | | | | | |
| Protrusion thickness (μm) = | 56 | 55 | 82 | 82 | 156 | 104 | 0 | 190 | 201 |
| thickness of stretchable | | | | | | | | | |
| material including | | | | | | | | | |
| protrusions of through-holes − | | | | | | | | | |
| thickness of stretchable material | | | | | | | | | |
| not including protrusions of | | | | | | | | | |
| through-holes (μm) | | | | | | | | | |
| Tensile stress at 300% elongation | 3.6 | 4.41 | 3.83 | 4 | 4.59 | 4.42 | 3.88 | 3.65 | 4.23 |
| for first time (N/25 mm) | | | | | | | | | |
| Tensile stress at 150% elongation | 0.7 | 0.79 | 0.65 | 0.78 | 0.7 | 0.74 | 0.85 | 0.79 | 0.72 |
| for second time (N/25 mm) | | | | | | | | | |
| Tensile stress at 300% elongation | 3.54 | 4.32 | 3.83 | 4 | 4.62 | 4.45 | 3.94 | 3.69 | 4.25 |
| for second time (N/25 mm) | | | | | | | | | |
| Tensile stress at 250% elongation | 0.67 | 0.72 | 0.55 | 0.62 | 0.52 | 0.51 | 0.65 | 0.64 | 0.51 |
| for second time (N/25 mm) | | | | | | | | | |
| Stress at MD fracture (N/25 mm) | 7 | 7.1 | — | — | — | — | — | 8.8 | 7.7 |
| Elongation rate at MD fracture (%) | 212 | 184 | — | — | — | — | — | 368 | 272 |
| Tensile stress at CD fracture | 5.5 | 6.6 | — | — | — | — | — | 6.3 | 7.8 |
| (N/25 mm) | | | | | | | | | |
| Elongation rate at CD fracture (%) | 557 | 606 | — | — | — | — | — | 629 | 674 |
| MD length of through-holes (μm) | 421 | 534 | — | — | — | — | — | 348 | 484 |
| CD length of through-holes (μm) | 293 | 390 | — | — | — | — | — | 330 | 412 |
| MD length of through-holes at | 454 | 574 | — | — | — | — | — | 329 | 588 |
| 300% elongation (μm) | | | | | | | | | |
| CD length of through-holes at | 751 | 1021 | — | — | — | — | — | 714 | 1042 |
| 300% elongation (μm) | | | | | | | | | |
| Coefficient of friction with | 0.31 | 0.28 | — | — | — | — | 0.38 | 0.4 | 0.29 |
| respect to iron | | | | | | | | | |
| Coefficient of friction with respect | 4.9 | 3.5 | — | — | — | — | 5.5 | 6 | 7.2 |
| to commercially available diaper | | | | | | | | | |
| Air permeability (cm³/cm² · s) | 68 | 59 | 73 | 70 | 73 | 69 | 0 | 80 | 67 |

According to Table 1 above, since Examples 1 to 6 and Comparative Examples 2 and 3 have a plurality of through-holes, high air permeability of 50 (cm³/cm²·s) or greater is achieved. In addition, the height of the protrusions formed on the outer edges of the through-holes (value of “(the thickness of the stretchable material including the protrusions of the through-holes)−(the thickness of the stretchable material not including the protrusions of the through-holes)”) exceeded 190 μm in Comparative Examples 2 and 3 but was kept to 190 μm or less in Examples 1 to 6. Therefore, the coefficient of dynamic friction with respect to the commercially available diaper can be kept low (not greater than 5.5).

Accordingly, it was found that when staggered through-holes are flattened at 80° C. or higher and when through-holes arranged in a lattice are flattened at 80° C. or higher, the height of the protrusions is kept to 190 μm or less and even 160 μm or less.

Further, in Examples 1 to 6, the tensile stress at 300% elongation for a first time (N/25 mm), the tensile stress at 150% elongation for a second time (N/25 mm), the tensile stress at 300% elongation for a second time (N/25 mm), the return stress at 250% elongation for a second time (N/25 mm), the stress at MD fracture (N/25 mm), the elongation rate at MD fracture (%), the tensile stress at CD fracture (N/25 mm), and the elongation rate at CD fracture (%) exhibited numerical values suitable for practical use as a stretchable material. For example, by setting the tensile stress at 150% elongation for a second time to 2 N/25 mm or less, the clothing article can be easily stretched when worn on the body, and by setting the return stress at 250% elongation for a second time to 0.2 N/25 mm or greater, mechanical properties suited to fitting the body after being worn on the body can be achieved (see FIG. 11 for details).

In addition, in the examples, a white master batch was added to the core layer, and a block copolymer was used for the skin layers, but when a white master batch is not added to the core layer and the skin layers are plastically deformed, the contrast difference of portions other than the through-holes relative to a polyethylene moisture-permeable sheet of a commercially available diaper (evaluated by ImageJ software) was approximately 45 (stretchable member: 183−polyethylene sheet: 138). Further, when the skin layers were made of a higher-gloss homopolyolefin (homopolypropylene), the contrast difference relative to a polyethylene sheet was approximately 74 (stretchable member: 208−polyethylene sheet: 134).

### REFERENCE NUMERALS

1 Diaper (clothing article)
10 Stretchable material
11a, 11b Skin layer
12 Core layer
15 Through-hole
15b Protrusion
20 Stretchable member
22 Heat needle
23a, 23b Roll
27a, 27b, 27c Shape retaining part
28a, 28b Stretchable part
A Diameter
H Height.

1. A stretchable material comprising:
a core layer containing an elastomer; and
a skin layer provided on a main surface of the core layer,
the stretchable material having a plurality of through-holes passing through the core layer and the skin layer, and
a height of protrusions formed on the outer edges of the plurality of through-holes being not greater than 160 μm.

2. The stretchable material according to claim 1, wherein the height of the protrusions is not greater than 100 μm.

3. The stretchable material according to claim 1, wherein a proportion of an area occupied by the plurality of through-holes with respect to the stretchable material is from 0.5% to 30%.

4. The stretchable material according to claim 1, wherein the plurality of through-holes have a circular shape, and
a diameter of the plurality of through-holes is from 0.2 mm to 3 mm.

5. The stretchable material according to claim 1, wherein an air permeability is not less than 10 (cm³/cm²·s).

6. The stretchable material according to claim 1, wherein a tensile stress at 150% elongation for a second time is not greater than 2 N/25 mm.

7. The stretchable material according to claim 1, wherein a return stress at 250% elongation for a second time is not less than 0.2 N/25 mm.

8. The stretchable material according to claim 1, wherein an elongation rate when the stretchable material is stretched in at least one direction is not less than 150%.

9. The stretchable material according to claim 1, wherein a tensile strength when the stretchable material is stretched in at least one direction is not less than 1 N/25 mm.

10. A stretchable member comprising:
a stretchable part having a structure in which the skin layer of the stretchable material described in claim 1 is plastically deformed; and
a shape retaining part in which the layer structure of the stretchable material is maintained.

11. The stretchable member according to claim 10, wherein a black/white contrast difference between portions other than the plurality of through-holes in the stretchable part and a moisture-permeable polyethylene sheet of a diaper is not less than 55.

12. A production method for a stretchable material including a core layer containing an elastomer and a skin layer provided on a main surface of the core layer, the production method comprising:
forming a plurality of through-holes passing through the core layer and the skin layer such that a height of protrusions formed on the outer edges of the plurality of through-holes is not greater than 160 μm.

13. The production method for a stretchable material according to claim 12, wherein in the step described above, the plurality of through-holes are formed by passing a plurality of heat needles through the core layer and the skin layer.

14. The production method for a stretchable material according to claim 12, wherein in the step described above, the plurality of through-holes are formed by die cutting.

15. The production method for a stretchable material according to claim 12, wherein in the step described above, the stretchable material in which the plurality of through-holes are formed is flattened at a temperature of not lower than 80° C.

16. A production method for a stretchable member comprising:
elongating at least a portion of the stretchable material described in claim 1 and plastically deforming at least a portion of the skin layer.

17. A clothing article comprising the stretchable material described in claim 12 or the stretchable member described in claim 10 or 11.

18. A stretchable material comprising:
a core layer containing an elastomer; and
a skin layer provided on a main surface of the core layer, the skin layer being plastically deformed,
the core layer containing no white master batch, and/or the skin layer being formed from a homopolyolefin, and
a black/white contrast difference relative to a moisture-permeable polyethylene sheet being not less than 55.
